(19) United States
(12) Patent Application Publication
(10) Pub. No.: US 2011/0262794 A1
(43) Pub. Date: Oct. 27, 2011

(54) BATTERY PACK AND COOLING SYSTEM FOR A BATTERY PACK

(76) Inventor: Jihyoung YOON, Suwon-si (KR)

(21) Appl. No.: 12/982,254

(22) Filed: Dec. 30, 2010

Related U.S. Application Data
(60) Provisional application No. 61/282,911, filed on Apr. 21, 2010.

(51) Int. Cl. H01M 10/50

(52) U.S. Cl. 429/120

(57) ABSTRACT

A battery pack and a cooling system for a battery pack that includes a plurality of battery cells, the battery pack including a plurality of battery cells; a first refrigerant circulation pipe; and a second refrigerant circulation pipe adjacent to the first refrigerant circulation pipe, wherein the first refrigerant circulation pipe is configured to direct a refrigerant along a first circulation pathway, the second refrigerant circulation pipe is configured to direct the refrigerant along a second circulation pathway counter to the first circulation pathway, and at least one of the first refrigerant circulation pipe and the second refrigerant circulation pipe is in thermal co-operation with the battery cells.

### CROSS-REFERENCE TO RELATED APPLICATION

The present application claims priority under 35 U.S.C. §119(e) to U.S. Provisional Application No. 61/282,911, filed on Apr. 21, 2010, and entitled: “BATTERY PACK,” which is incorporated herein by reference in its entirety.

### BACKGROUND

1. Field

Embodiments relate to a battery pack and a cooling system for a battery pack.

2. Description of the Related Art

Unlike a primary battery that is not rechargeable, a secondary battery is rechargeable and dischargeable. Such a secondary battery may be used in a battery pack formed by electrically connecting a plurality of battery cells to each other, so that the secondary battery may be used in, e.g., electric vehicles and uninterruptable power supplies, which have larger capacity requirements than portable electronic devices.

When being repeatedly charged and discharged, each battery cell of a battery pack may be heated. If heat generated by the repeated charging and discharging is not cooled in the battery pack, each battery cell may be degraded. Furthermore, heat generated from each battery cell may degrade performance of the battery pack as a whole.

### SUMMARY

Embodiments are directed to a battery pack a cooling system for a battery pack.

At least one of the above and other features and advantages may be realized by providing a battery pack including a plurality of battery cells; a first refrigerant circulation pipe; and a second refrigerant circulation pipe adjacent to the first refrigerant circulation pipe, wherein the first refrigerant circulation pipe is configured to direct a refrigerant along a first circulation pathway, the second refrigerant circulation pipe is configured to direct the refrigerant along a second circulation pathway counter to the first circulation pathway, and at least one of the first refrigerant circulation pipe and the second refrigerant circulation pipe is in thermal co-operation with the battery cells.

The first refrigerant circulation pipe may be configured to direct the refrigerant along the first circulation pathway in a first flow direction, and the second refrigerant circulation pipe may be configured to direct the refrigerant along the second circulation pathway in a second flow direction that runs counter to the first flow direction.

The first refrigerant circulation pipe may be in thermal co-operation with the second refrigerant circulation pipe.

The first refrigerant circulation pipe may be between the battery cells and the second refrigerant circulation pipe.

The second refrigerant circulation pipe may have a shape substantially identical to a shape of the first refrigerant circulation pipe.

At least one of the first refrigerant circulation pipe and the second refrigerant circulation pipe may contact a surface of the battery cells to be cooled.

The battery may further include a first refrigerant supply pipe connected to a first end of the first refrigerant circulation pipe, a second refrigerant supply pipe connected to a second end of the second refrigerant circulation pipe, a pumping system configured to supply the refrigerant to the first and second refrigerant supply pipes, a first refrigerant discharge pipe connected to a second end of the first refrigerant circulation pipe, the second end of the first refrigerant circulation pipe being opposite to the first end thereof, a second refrigerant discharge pipe connected to a first end of the second refrigerant circulation pipe, the first end of the second refrigerant circulation pipe being opposite to the second end thereof, and a heat dissipation storage system connected to the first and second refrigerant discharge pipes, the heat dissipation storage system being configured to cool and store refrigerant from the first and second refrigerant discharge pipes and being configured to supply cooled refrigerant to the pumping system.

The pumping system may include a single pump connected to the first refrigerant supply pipe and the second refrigerant supply pipe.

The heat dissipation storage system may include a single heat dissipation storage unit connected to the first and second refrigerant discharge pipes.

The pumping system may include a plurality of pumps, at least one pump being connected to the first refrigerant supply pipe and at least one other pump being connected to the second refrigerant supply pipe.

The heat dissipation storage system may include a plurality of heat dissipation storage units, at least one heat dissipation storage unit being connected to the first refrigerant discharge pipe and at least one other heat dissipation storage unit being connected to the second refrigerant discharge pipe.

The battery pack may further include a control unit operatively coupled with the pumping system, the control unit being configured to measure a temperature of the battery cells and control operation of the pumping system.

The control unit may be configured to activate the pumping system when a temperature of the battery cells exceeds a predetermined reference temperature.

The battery pack may further include a branch supply pipe connected between the pumping system and the first and second refrigerant supply pipes.

The battery pack may further include a branch discharge pipe connected between the first and second refrigerant discharge pipes and the heat dissipation storage system.

The first refrigerant circulation pipe may have a width about equal to a width of the second refrigerant supply pipe.

The battery cells may have a width about equal to a sum of the widths of the first and second refrigerant circulation pipes.

The first and second refrigerant circulation pipes may each include parallel portions and connecting portions, each parallel portion extending along a widthwise direction of a battery cell and the connecting portions connecting the parallel portions at alternating ends of the parallel portions.

The connecting portion may be a straight pipe extending between the parallel portions.

The connecting portion may be a curved pipe extending between the parallel portions.

The first refrigerant circulation pipe may be coplanar with the second refrigerant circulation pipe.

The connecting portion may be a curved pipe extending between the parallel portions.

At least one of the above and other features and advantages may also be realized by providing a cooling system for a battery pack that includes a plurality of battery cells, the cooling system including a first refrigerant circulation pipe; and a second refrigerant circulation pipe adjacent to the first refrigerant circulation pipe, wherein the first refrigerant circulation pipe contacts a surface of the battery cells to be cooled and is configured to direct a refrigerant along a first circulation pathway in a first flow direction, and the second refrigerant circulation pipe co-operates with the first refrigerant circulation pipe and is configured to direct the refrigerant along a second circulation pathway in a second flow direction that runs counter to the first flow direction.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a perspective view of a battery pack according to an embodiment;

FIG. 2A illustrates a schematic view of an example of a refrigerant supply device and a circulation process of refrigerant in the battery pack of FIG. 1;

FIG. 2B illustrates a schematic view of another example of a refrigerant supply device and a circulation process of refrigerant in the battery pack of FIG. 1;

FIG. 3 illustrates a perspective view of a lower portion of a battery pack according to another embodiment;

FIG. 4 illustrates a perspective view of lower portion of a battery pack according to yet another embodiment;

FIG. 5 illustrates a perspective view of a battery pack according to still another embodiment;

FIG. 6 illustrates a perspective view of lower portion of a battery pack according to still another embodiment;

FIG. 7 illustrates a perspective view of lower portion of a battery pack according to still another embodiment;

FIG. 8 illustrates a perspective view of lower portion of a battery pack according to still another embodiment; and

FIG. 9 illustrates a perspective view of lower portion of a battery pack according to still another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

Hereinafter, a configuration of a battery pack according to an embodiment will now be described.

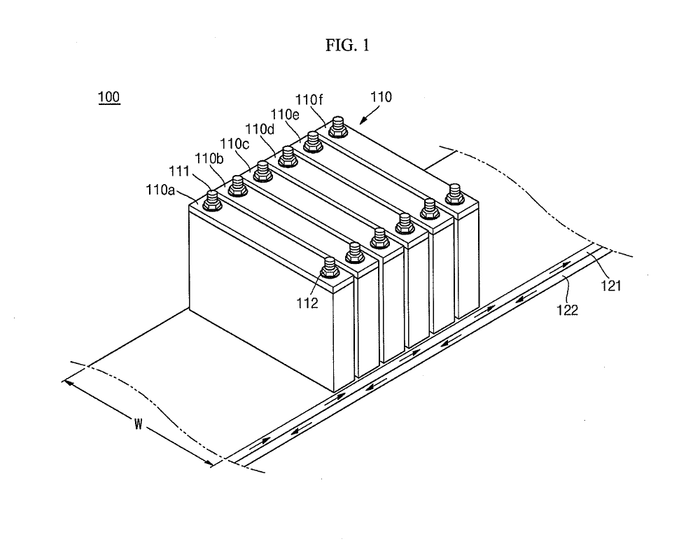

FIG. 1 illustrates a perspective view of battery pack according to an embodiment.

Referring to FIG. 1, a battery pack 100 according to the present embodiment may include battery cells 110, a first refrigerant circulation pipe 121, and a second refrigerant circulation pipe 122.

The battery cell 110 may include a first electrode terminal 111 and a second electrode terminal 112. The first electrode terminal 111 and the second electrode terminal 112 may be disposed at an upper portion of the battery cell 110. However, positions of the first electrode terminal 111 and the second electrode terminal 112 are not limited thereto. The first electrode terminal 111 may have a positive or negative polarity. The second electrode terminal 112 may a polarity opposite to that of the first electrode terminal 111. The battery cells 110 may be arrayed from a first side to a second side. The battery cells 110 may be classified into first through sixth battery cells 110a, 110b, 110c, 110d, e, and 110f in order from the first side to the second side. However, the number of the battery cells 110 is not limited thereto. Secondary batteries, which are chargeable and dischargeable, may be used as the battery cells 110. Hereinafter, a distance across a large side of the battery cell 110 is referred to as a width of the battery cell 110, and a direction along the width is referred to as a width direction.

The first refrigerant circulation pipe 121 may extend from the first side of the battery cells 110 to the second side and may have a pipe shape, e.g., may be hollow at an inside thereof. The first refrigerant circulation pipe 121 may have a first surface that is adjacent to or in thermal co-operation with the outer surfaces of the battery cells 110. For example, the first or upper surface of the first refrigerant circulation pipe 121 may contact lower surfaces of the battery cells 110. A width W of the battery pack 100, e.g., the width of one of the battery cells 110, may be about equal to a width W of the first refrigerant circulation pipe 121. Accordingly, heat generated when the battery cells 110 are charged and discharged may be effectively cooled or dissipated. Since the width of the battery cells 110 may be about equal to the width W of the first refrigerant circulation pipe 121, an arrangement and structure of the battery cells 110 may be stably formed in the battery pack 100. In an implementation, the first refrigerant circulation pipe 121 may include, e.g., copper and/or aluminum, which have high thermal conductivity. The first refrigerant circulation pipe 121 may be configured to supply refrigerant from the first side of the battery cells 110 through the hollow at the inside. For example, the first refrigerant circulation pipe 121 may be configured to supply refrigerant from the side where the first battery cell 110a is disposed, i.e., may be configured to direct refrigerant along a first circulation pathway.

The second refrigerant circulation pipe 122 may extend from the first side of the battery cells 110 to the second side and may have a pipe shape, e.g., may be hollow at an inside thereof. The second refrigerant circulation pipe 122 may be adjacent to or in thermal co-operation with a second surface of the first refrigerant circulation pipe 121. For example, an upper surface of the second refrigerant circulation pipe 122 may contact the second or lower surface of the first refrigerant circulation pipe 121. The width W of the battery cells 110, the width W of the first refrigerant circulation pipe 121, and a width W of the second refrigerant circulation pipe 122 may be about equal. Thus, the battery cells 110, the first refrigerant circulation pipe 121, and the second refrigerant circulation pipe 122 may be structurally stable in the battery pack 100. The second refrigerant circulation pipe 122 may include, e.g., copper and/or aluminum, which have high thermal conductivity. The second refrigerant circulation pipe 122 may be configured to supply refrigerant from the second side of the battery cells 110 through the hollow at the inside. For example, the second refrigerant circulation pipe 122 may be configured to supply refrigerant from the side where the sixth battery cell 110f is disposed, i.e., along a second circulation pathway counter to the first circulation pathway. The second refrigerant circulation pipe 122 may supply refrigerant from the second side to effectively cool heated refrigerant at the second side of the first refrigerant circulation pipe 121 contacting or in thermal co-operation with the second refrigerant circulation pipe 122.

Refrigerant in the first refrigerant circulation pipe 121 may be heated while passing along the first through sixth battery cells 110a, 110b, 110c, 110d, 110e, and 110f. Since refrigerant may absorb heat from the battery cells 110, a temperature of the refrigerant may vary from the first side of a refrigerant circulation pipe 121 to the second side. Thus, temperature variation may occur between a battery cell 110 at the first side and a battery cell 110 at the second side. However, in the battery pack 100 according to the present embodiment, the second refrigerant circulation pipe 122 may contact or may be in thermal co-operation with the first refrigerant circulation pipe 121 to decrease a temperature of heated refrigerant at the second side of the first refrigerant circulation pipe 121. Thus, the battery pack 100 may uniformly cool the battery cells 110.

Hereinafter, a refrigerant supply device and a circulation process of refrigerant in a battery pack according to an embodiment will now be described.

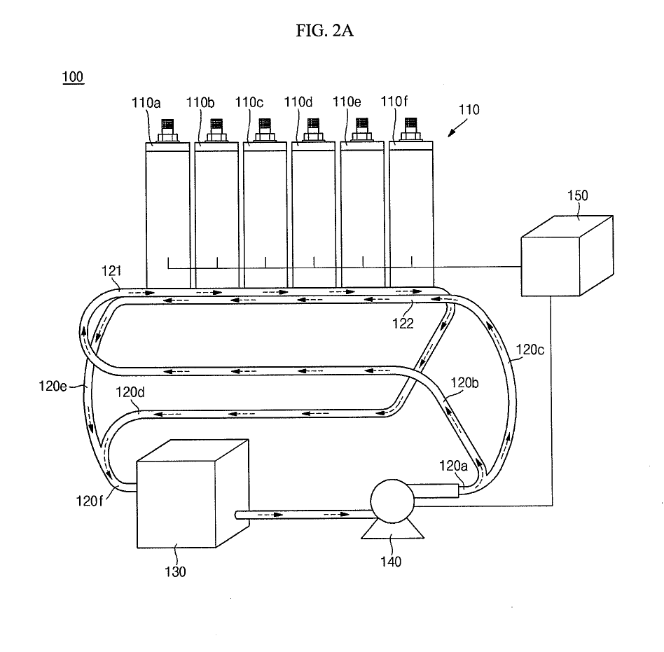

FIG. 2A illustrates a schematic view of an example of a refrigerant supply device and a circulation process of refrigerant in the battery pack of FIG. 1. FIG. 2B illustrates a schematic view of another example of a refrigerant supply device and a circulation process of refrigerant in the battery pack of FIG. 1.

Referring to FIG. 2A, the battery pack 100 may further include a refrigerant supply device. The refrigerant supply device may include a branch supply pipe 120a, a first refrigerant supply pipe 120b, a second refrigerant supply pipe 120c, a first refrigerator discharge pipe 120d, a second refrigerator discharge pipe 120e, a branch discharge pipe 120f, a heat dissipation storage system 130, a pumping system 140, and a control unit 150.

The branch supply pipe 120a is connected to the pumping system 140 to be described below to function as a passage to which refrigerant is introduced.

The first refrigerant supply pipe 120b may have a pipe shape, e.g., may be hollow at an inside thereof. A first end of the first refrigerant supply pipe 120b may be connected to the branch supply pipe 120a. A second end of the first refrigerant supply pipe 120b may be connected to a first side of the first refrigerant circulation pipe 121. The first refrigerant supply pipe 120b may function as a passage configured to introduce refrigerant from the branch supply pipe 120a to the first refrigerant circulation pipe 121.

The second refrigerant supply pipe 120c may have a pipe shape, e.g., may be hollow at an inside thereof. A first end of the second refrigerant supply pipe 120c may be connected to the branch supply pipe 120a. A second end of the second refrigerant supply pipe 120c may be connected to the second side of the second refrigerant circulation pipe 122. The second refrigerant supply pipe 120c may function as a passage configured to introduce refrigerant from the branch supply pipe 120a to the second refrigerant circulation pipe 122.

The first refrigerant discharge pipe 120d may have a pipe shape, e.g., may be hollow at an inside thereof. A first end of the first refrigerant discharge pipe 120d may be connected to a second side of the first refrigerant circulation pipe 121. The first refrigerant discharge pipe 120d may function as a passage through which refrigerant of the first refrigerant circulation pipe 121 is discharged after cooling the battery cells 110.

The second refrigerant discharge pipe 120e may have a pipe shape, e.g., may be hollow at an inside thereof. A first end of the second refrigerant discharge pipe 120e may be connected to a first side of the second refrigerant circulation pipe 122. The second refrigerant discharge pipe 120e may function as a passage through which refrigerant of the second refrigerant circulation pipe 122 is discharged after cooling refrigerant of the first refrigerant circulation pipe 121.

The branch discharge pipe 120f may have a pipe shape, e.g., may be hollow at an inside thereof. The branch discharge pipe 120f may be connected to a second end of the first refrigerant discharge pipe 120d and a second end of the second refrigerant discharge pipe 120e. The branch discharge pipe 120f may function as a passage to discharge refrigerant of the first refrigerant discharge pipe 120d and refrigerator of the second refrigerant discharge pipe 120e to the heat dissipation storage system 130 to be described below.

The heat dissipation storage system 130 may cool refrigerant introduced through the branch discharge pipe 120f. For example, the heat dissipation storage system 130 may include a heat dissipation plate. The heat dissipation storage system 130 may store cooled refrigerant.

The pump 140 may introduce refrigerant cooled and stored at the heat dissipation storage unit 130 to the branch supply pipe 120a.

The control unit 150 may measure a temperature of the battery cells 110 to control the heat dissipation storage unit 130 and the pump 140. For example, when a temperature of the battery cell 110 is greater than a predetermined reference temperature, the control unit 150 may operate the heat dissipation storage system 130 and the pumping system 140, i.e., the control unit 150 may be operatively coupled to the heat dissipation storage system 130 and the pumping system 140. When a temperature of the battery cell 110 is less than the predetermined reference temperature, the control unit 150 may stop the heat dissipation storage system 130 and the pumping system 140. Here, the predetermined reference temperature may be a temperature at which performance of the battery pack 100 begins to degrade. For example, the predetermined reference temperature may be about 60° C. Instead of continually circulating refrigerant, the battery cells 110 may be cooled only at a necessary or desired time by operation of the control unit 150. Thus, the control unit 150 may suppress loss of the entire power of the battery pack 100.

As illustrated in FIG. 2A, the refrigerant supply device may include the dissipation storage system 130 including a single dissipation storage unit and the pumping system 140 including a single pump. However, in an implementation, the refrigerant supply device may include a plurality of heat dissipation storage units and a plurality of pumps. For example, as illustrated in FIG. 2B, a refrigerant supply device may include a heat dissipation storage system 130 and 130′ including two heat dissipation storage units and a pumping system 140 and 140′ including two pumps connected between the control unit 150 and the heat dissipation storage system 130 and 130′. The second refrigerant supply pipe 120c for supplying refrigerant to the second refrigerant circulation pipe 122 may be connected to a branch supply pipe 120a′ connected to one of the pumps of the pumping system 140′. The second refrigerant discharge pipe 120e for discharging refrigerant from the second refrigerant circulation pipe 122 may be connected to a branch discharge pipe 120f connected to one of the heat dissipation storage units of the heat dissipation storage system 130′. The refrigerant supply device illustrated in FIG. 2B may use the two pumps of the pumping system 140 and 140′ to independently control circulation of refrigerant through the first refrigerant circulation pipe 121 and circulation of refrigerant through the second refrigerant circulation pipe 122, so as to prevent a pump overload from occurring, e.g., in a case where a single pump is used to control both circulation of refrigerant through the first refrigerant circulation pipe 121 and circulation of refrigerant through the second refrigerant circulation pipe 122.

Hereinafter, a configuration of a battery pack according to another embodiment will now be described.

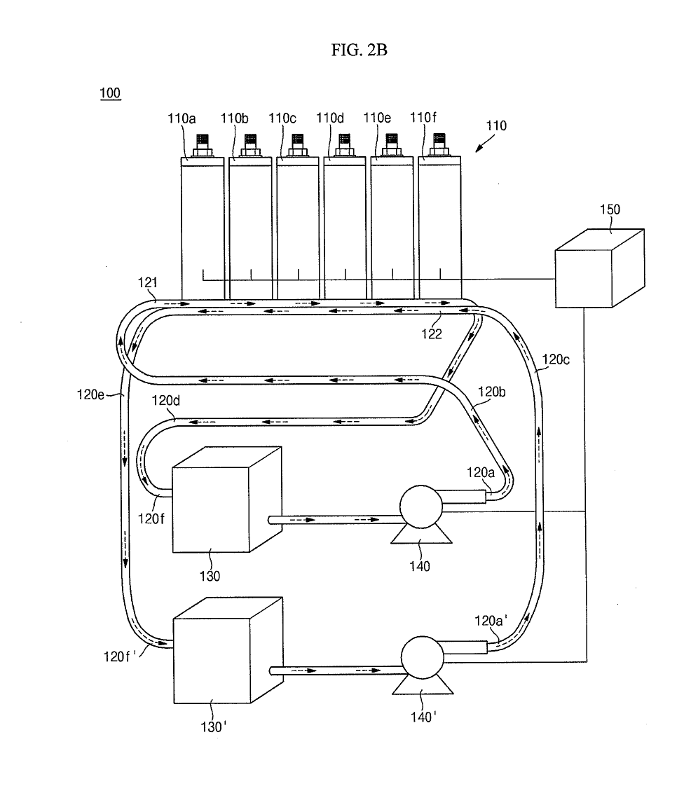

FIG. 3 is a perspective view of a lower portion of a battery pack according to another embodiment.

Referring to FIG. 3, a battery pack 200 according to the present embodiment is different from the battery pack 100 of FIG. 1 in structures of a first refrigerant circulation pipe 221 and a second refrigerant circulation pipe 222. Thus, the battery pack 200 will now be described with respect to the first refrigerant circulation pipe 221 and the second refrigerant circulation pipe 222. Like reference numerals denote like elements in the battery pack 100 of FIG. 1 and the battery pack 200, and repeated descriptions thereof will be omitted.

The first refrigerant circulation pipe 221 may extend from the first side of the battery cells 110 to the second side, may have a pipe shape, e.g., may behollow at an inside thereof. The first refrigerant circulation pipe 221 may have a first surface that is adjacent to or in thermal co-operation with outer surfaces of the battery cells 110. For example, the first or upper surface of the first refrigerant circulation pipe 221 may contact lower surfaces of the battery cells 110. The first refrigerant circulation pipe 221 may be configured to supply refrigerant from the first side of the battery cells 110 through the hollow at the inside. For example, the first refrigerant circulation pipe 221 may be configured to supply refrigerant from the side where the first battery cell 110a is disposed. The first refrigerant circulation pipe 221 may include a first parallel portion 221a, a connecting portion 221b, and a second parallel portion 221c.

A first surface of the first parallel portion 221a may be adjacent to or in contact with at least one of the battery cells, e.g., the first battery cell 110a. The first parallel portion 221a may extend along the width direction of the first battery cell 110a.

The connecting portion 221b may be bent and may extend from the first parallel portion 221a to the second side of the battery cells 110.

The second parallel portion 221c may be bent and may extend from the connecting portion 221b. A first surface of the second parallel portion 221c may be adjacent to or in thermal co-operation with the second battery cell 110b adjacent to the first battery cell 110a. The second parallel portion 221c may extend along the width direction of the second battery cell 110b.

The first parallel portion 221a, the connecting portion 221b, and the second parallel portion 221c of the first refrigerant circulation pipe 221 may be repeatedly formed according to the number and the size of the battery cells 110, i.e., the connecting portion 221b may connect the first and second parallel portions 221a and 221c at alternating ends thereof. The connecting portion 221b may be a straight pipe extending between the first and second parallel portions 221a and 221c.

The second refrigerant circulation pipe 222 may have the same shape as the first refrigerant circulation pipe 221. The second refrigerant circulation pipe 222 may be adjacent to or in thermal co-operation with a second surface of the first refrigerant circulation pipe 221. For example, the second refrigerant circulation pipe 222 may contact the second or lower surface of the first refrigerant circulation pipe 221. The second refrigerant circulation pipe 222 may be configured to supply refrigerant from the second side of the battery cells 110 through the hollow at the inside. The second refrigerant circulation pipe 222 may overlap and be parallel to the second surface of the first refrigerant circulation pipe 221 to correspond to the position of the first refrigerant circulation pipe 221. The second refrigerant circulation pipe 222 may include a first parallel portion 222a, a connecting portion 222b, and a second parallel portion 222c.

A first surface of the first parallel portion 222a may be adjacent to or in contact with the second surface of the first parallel portion 221a of the first refrigerant circulation pipe 221. The first parallel portion 222a may extend along the width direction of the first battery cell 110a.

The connecting portion 222b may be bent and may extend from the first parallel portion 222a to the second side of the battery cells 110. The connecting portion 222b may be adjacent to or in contact with the connecting portion 221b of the first refrigerant circulation pipe 221.

The second parallel portion 222c may be bent and may extend from the connecting portion 222b. The second parallel portion 222c may be adjacent to or in contact with the second parallel portion 221c of the first refrigerant circulation pipe 221. The second parallel portion 222c may extend along the width direction of the second battery cell 110b.

The first parallel portion 222a, the connecting portion 222b, and the second parallel portion 222c of the second refrigerant circulation pipe 222 may be repeatedly formed according to the number and the size of the battery cells 110, i.e., the connecting portion 222b may connect the first and second parallel portions 222a and 222c at alternating ends thereof. The connecting portion 222b may be a straight pipe extending between the first and second parallel portions 222a and 222c.

Hereinafter, a configuration of a battery pack according to yet another embodiment will now be described.

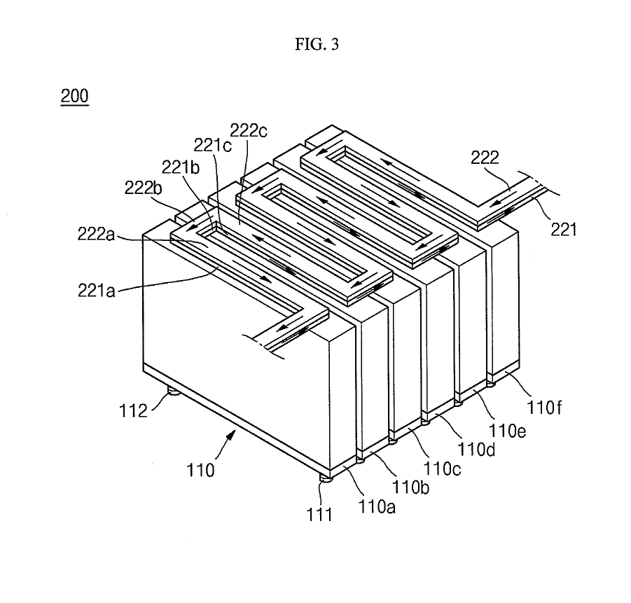

FIG. 4 illustrates a perspective view of a lower portion of a battery pack according to yet another embodiment.

Referring to FIG. 4, a battery pack 300 according to the present embodiment is different from the battery pack 100 of FIG. 1 in structures of a first refrigerant circulation pipe 321 and a second refrigerant circulation pipe 322. Thus, the battery pack 300 will now be described with respect to the first refrigerant circulation pipe 321 and the second refrigerant circulation pipe 322. Like reference numerals denote like elements in the battery pack 100 of FIG. 1 and the battery pack 300, and repeated descriptions thereof will be omitted.

The first refrigerant circulation pipe 321 may extend from the first side of the battery cells 110 to the second side and may have a pipe shape, e.g., may be hollow at an inside thereof. The first refrigerant circulation pipe 321 may have a first surface adjacent to or in thermal co-operation with the battery cells 110. For example, the first or upper surface of the first refrigerant circulation pipe 321 may contact lower surfaces of the battery cells 110. The first refrigerant circulation pipe 321 may be configured to supply refrigerant from the first side of the battery cells 110 through the hollow at the inside. For example, the first refrigerant circulation pipe 321 may be configured to supply refrigerant from the side where the first battery cell 110a is disposed. The first refrigerant circulation pipe 321 may include a first parallel portion 321a, a second parallel portion 321b, and a connecting portion 321c.

The first parallel portion 321a may have a first surface that is adjacent to or in thermal co-operation with at least one of the battery cells 110, e.g., the first battery cell 110a. The first parallel portion 321a may extend along the width direction of the first battery cell 110a.

The second parallel portion 321b may have a first surface that is adjacent to or in contact with the second battery cell 110b adjacent to the first battery cell 110a. The second parallel portion 321b may extend along the width direction of the second battery cell 110b.

The connecting portion 321c may connect the first parallel portion 321a to the second parallel portion 321b in a curve shape, i.e., may be a curved pipe. Due to the curve shape of the connecting portion 321c, refrigerant may flow efficiently.

The first parallel portion 321a, the second parallel portion 321b, and the connecting portion 321c of the first refrigerant circulation pipe 321 may be repeatedly formed according to the number and the size of the battery cells 110, i.e., the connecting portion 321c may connect the first and second parallel portions 321a and 321b at alternating ends thereof.

The second refrigerant circulation pipe 322 may have the same shape as the first refrigerant circulation pipe 321. The second refrigerant circulation pipe 322 may be adjacent to or in thermal co-operation with a second surface of the first refrigerant circulation pipe 321. For example, the second refrigerant circulation pipe 322 may be adjacent to or in thermal co-operation with the second or lower surface of the first refrigerant circulation pipe 321. The second refrigerant circulation pipe 322 may be configured to supply refrigerant to the second side of the battery cells 110 through the hollow at the inside. The second refrigerant circulation pipe 322 may overlap and may be parallel to the second surface of the first refrigerant circulation pipe 321 to correspond to the position of the first refrigerant circulation pipe 321. The second refrigerant circulation pipe 322 may include a first parallel portion 322a, a second parallel portion 322b, and a connecting portion 322c.

The first parallel portion 322a may have a first surface that is adjacent to or in thermal co-operation with the second surface of the first parallel portion 321a of the first refrigerant circulation pipe 321. The first parallel portion 322a may extend along the width direction of the first battery cell 110a.

The second parallel portion 322b may have a first surface that is in thermal co-operation with the second surface of the second parallel portion 321b of the first refrigerant circulation pipe 321. The second parallel portion 322b may extend along the width direction of the second battery cell 110b.

The connecting portion 322c may connect the first parallel portion 322a to the second parallel portion 322b in a curve shape, i.e., may be a curved pipe. Due to the curve shape of the connecting portion 322c, refrigerant may flow efficiently.

The first parallel portion 322a, the second parallel portion 322b, and the connecting portion 322c of the second refrigerant circulation pipe 322 may be repeatedly formed according to the number and the size of the battery cells 110, i.e., the connecting portion 322c may connect the first and second parallel portions 322a and 322c at alternating ends thereof.

Hereinafter, a configuration of a battery pack according to still another embodiment will now be described.

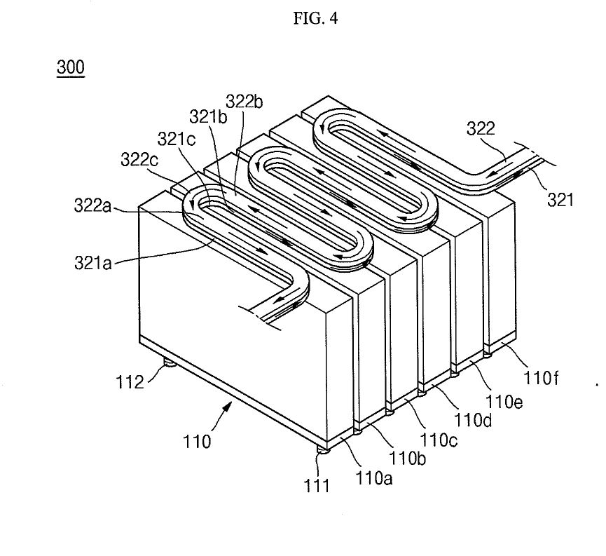

FIG. 5 illustrates a perspective view of a battery pack according to still another embodiment.

Referring to FIG. 5, a battery pack 400 according to the present embodiment is different from the battery pack 100 of FIG. 1 in structures of a first refrigerant circulation pipe 421 and a second refrigerant circulation pipe 422. Thus, the battery pack 400 will now be described with respect to the first refrigerant circulation pipe 421 and the second refrigerant circulation pipe 422. Like reference numerals denote like elements in the battery pack 100 of FIG. 1 and the battery pack 400, and repeated descriptions thereof will be omitted.

The first refrigerant circulation pipe 421 may extend from the first side of the battery cells 110 to the second side thereof and may have a pipe shape, e.g., may have a hollow at an inside thereof. The first refrigerant circulation pipe 421 may be adjacent to or in thermal co-operation with outer surfaces of the battery cells 110. For example, an upper surface of the first refrigerant circulation pipe 421 may contact lower surfaces of the battery cells 110. The first refrigerant circulation pipe 421 may include, e.g., copper and/or aluminum, which have high thermal conductivity. The first refrigerant circulation pipe 421 may be configured to supply refrigerant from the first side of the battery cells 110 through the hollow at the inside. For example, the first refrigerant circulation pipe 421 may be configured to supply refrigerant from the side where the first battery cell 110a is disposed.

The second refrigerant circulation pipe 422 may extend from the first side of the battery cells 110 to the second side thereof and may have a pipe shape, e.g., may have a hollow at an inside thereof. The second refrigerant circulation pipe 422 may be adjacent to or in thermal co-operation with outer surfaces of the battery cells 110 and to the first refrigerant circulation pipe 421. For example, the second refrigerant circulation pipe 422 may contact lower surfaces of the battery cells 110 and a side surface of the first refrigerant circulation pipe 421. The second refrigerant circulation pipe 422 may include, e.g., copper and/or aluminum, which have high thermal conductivity. The second refrigerant circulation pipe 422 may be configured to supply refrigerant from the second side of the battery cells 110 through the hollow at the inside. For example, the second refrigerant circulation pipe 422 may be configured to supply refrigerant from the side where the sixth battery cell 110f is disposed, i.e., counter to the first refrigerant circulation pipe 421.

A sum of a width W1 of the first refrigerant circulation pipe 421 and a width W2 of the second refrigerant circulation pipe 422 may be about equal to a width W of the battery cell 110. Accordingly, heat generated when the battery cells 110 are charged and discharged may be effectively cooled or dissipated by the first refrigerant circulation pipe 421 and the second refrigerant circulation pipe 422. As described above, the sum of the width W1 of the first refrigerant circulation pipe 421 and the width W2 of the second refrigerant circulation pipe 422 may be about equal to the width W of the battery cell 110. Thus, an arrangement and structure of the battery cells 110, the first refrigerant circulation pipe 421, and the second refrigerant circulation pipe 422 may be stable.

As described above, the first refrigerant circulation pipe 421 through which refrigerant is supplied from the first side may contact or may be in thermal co-operation with the second refrigerant circulation pipe 422 through which refrigerant is supplied from the second side. Thus, the battery cells 110 may be effectively cooled in a balanced state.

Hereinafter, a configuration of a battery pack according to still another embodiment will now be described.

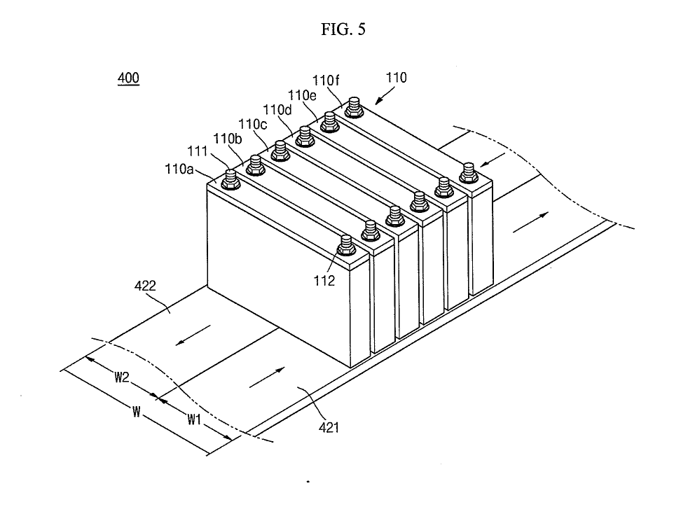

FIG. 6 illustrates a perspective view of a lower portion of a battery pack according to still another embodiment.

Referring to FIG. 6, a battery pack 500 according to the present embodiment is different from the battery pack 100 of FIG. 1 in structures of a first refrigerant circulation pipe 521 and a second refrigerant circulation pipe 522. Thus, the battery pack 500 will now be described with respect to the first refrigerant circulation pipe 521 and the second refrigerant circulation pipe 522. Like reference numerals denote like elements in the battery pack 100 of FIG. 1 and the battery pack 500, and repeated descriptions thereof will be omitted.

The first refrigerant circulation pipe 521 may extend from a first side of the battery cells 110 to a second side thereof and may have a pipe shape, e.g., may be hollow at an inside thereof. The first refrigerant circulation pipe 521 may have a first surface adjacent to or in thermal co-operation with the battery cells 110. For example, the first or upper surface of the first refrigerant circulation pipe 521 may contact lower surfaces of the battery cells 110. The first refrigerant circulation pipe 521 may be configured to supply refrigerant from the first side of the battery cells 110 through the hollow at the inside. For example, the first refrigerant circulation pipe 521 may be configured to supply refrigerant from the side where the first battery cell 110a is disposed. The first refrigerant circulation pipe 521 may include a first parallel portion 521a, a connecting portion 521b, and a second parallel portion 521c.

A first surface of the first parallel portion 521a may be adjacent to or in thermal co-operation with at least one of the battery cells 110, e.g., the first battery cell 110a. The first parallel portion 521a may extend along the width direction of the first battery cell 110a.

The connecting portion 521b may be bent and may extend from the first parallel portion 521a to the second side of the battery cells 110.

The second parallel portion 521c may be bent and may extend from the connecting portion 521b. A first surface of the second parallel portion 521c may be adjacent to or in thermal co-operation with the second battery cell 110b adjacent to the first battery cell 110a. The second parallel portion 521c may extend along the width direction of the second battery cell 110b.

The first parallel portion 521a, the connecting portion 521b, and the second parallel portion 521c of the first refrigerant circulation pipe 521 may be repeatedly formed according to the number and the size of the battery cells 110, i.e., the connecting portion 521b may connect the first and second parallel portions 521a and 521c at alternating ends thereof. The connecting portion 521b may be a straight pipe extending between the first and second parallel portions 521a and 521c.

The second refrigerant circulation pipe 522 may extend from the first side of the battery cells 110 to the second side thereof and may have a pipe shape, e.g., may be hollow at an inside thereof. The second refrigerant circulation pipe 522 may be adjacent to or in thermal co-operation with the battery cells 110 and the first refrigerant circulation pipe 521. The second refrigerant circulation pipe 522 may be configured to supply refrigerant from the second side of the battery cells 110 through the hollow at the inside. For example, the second refrigerant circulation pipe 522 may be configured to supply refrigerant from the side where the sixth battery cell 110f is disposed. The second refrigerant circulation pipe 522 may include a first parallel portion 522a, a connecting portion 522b, and a second parallel portion 522c.

A first surface of the first parallel portion 522a may be adjacent to or in thermal co-operation with the first battery cell 110a and the first parallel portion 521a of the first refrigerant circulation pipe 521. The second parallel portion 522a may extend along the width direction of the first battery cell 110a.

The connecting portion 522b may be bent and may extend from the first parallel portion 522a to the second side of the battery cells 110. The connecting portion 522b may be adjacent to or in thermal co-operation with the connecting portion 521b of the first refrigerant circulation pipe 521.

The second parallel portion 522c of the second refrigerant circulation pipe 522 may be bent and may extend from the connecting portion 522b. The second parallel portion 522c may be adjacent to or in thermal co-operation with the second parallel portion 521c of the first refrigerant circulation pipe 521 and the second battery cell 110b. The second parallel portion 522c may extend along the width direction of the second battery cell 110b.

The first parallel portion 522a, the connecting portion 522b, and the second parallel portion 522c of the second refrigerant circulation pipe 522 may be repeatedly formed according to the number and the size of the battery cells 110, i.e., the connecting portion 522b may connect the first and second parallel portions 522a and 522c at alternating ends thereof. The connecting portion 522b may be a straight pipe extending between the first and second parallel portions 522a and 522c

Hereinafter, a configuration of a battery pack according to still another embodiment will now be described.

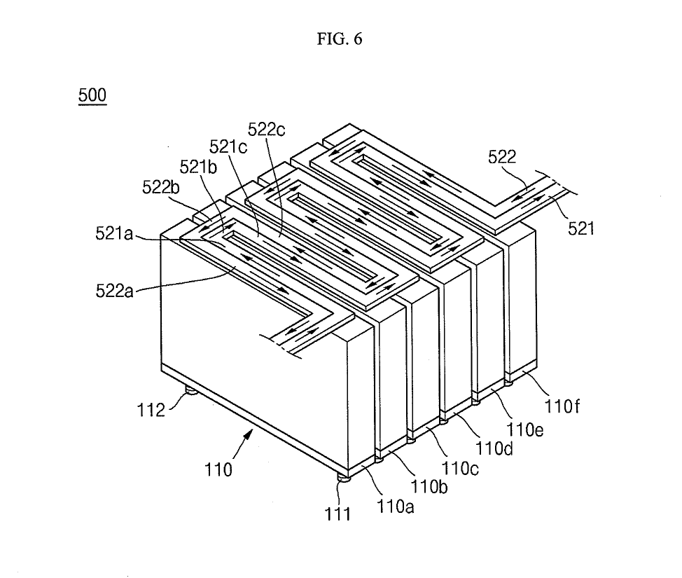

FIG. 7 illustrates a perspective view of a lower portion of a battery pack according to still another embodiment.

Referring to FIG. 7, a battery pack 600 according to the present embodiment is different from the battery pack 100 of FIG. 1 in structures of a first refrigerant circulation pipe 621 and a second refrigerant circulation pipe 622. Thus, the battery pack 600 will now be described with respect to the first refrigerant circulation pipe 621 and the second refrigerant circulation pipe 622. Like reference numerals denote like elements in the battery pack 100 of FIG. 1 and the battery pack 600, and repeated descriptions thereof will be omitted.

The first refrigerant circulation pipe 621 may extend from a first side of the battery cells 110 to a second side thereof and may have a pipe shape, e.g., may be hollow at an inside thereof. The first refrigerant circulation pipe 621 may have a first surface adjacent to or in thermal co-operation with the battery cells 110. For example, the first or upper surface of the first refrigerant circulation pipe 621 may contact lower surfaces of the battery cells 110. The first refrigerant circulation pipe 621 may be configured to supply refrigerant from the first side of the battery cells 110 through the hollow at the inside. For example, the first refrigerant circulation pipe 621 may be configured to supply refrigerant from the side where the first battery cell 110a is disposed. The first refrigerant circulation pipe 621 may include a first parallel portion 621a, a second parallel portion 621b, and a connecting portion 621c.

A first surface of the first parallel portion 621a may be adjacent to or in thermal co-operation with at least one of the battery cells 110, e.g., the first battery cell 110a. The first parallel portion 621a may extend along the width direction of the first battery cell 110a.

A first surface of the second parallel portion 621b may be adjacent to or in thermal co-operation with, e.g., the second battery cell 110b adjacent to the first battery cell 110a. The second parallel portion 621b may extend along the width direction of the second battery cell 110b.

The connecting portion 621c may connect the first parallel portion 621a to the second parallel portion 621b in a curve shape, i.e., may be a curved pipe. Due to the curve shape of the connecting portion 621c, refrigerant may flow efficiently.

The first parallel portion 621a, the second parallel portion 621b, and the connecting portion 621c of the first refrigerant circulation pipe 621 may be repeatedly formed according to the number and the size of the battery cells 110, i.e., the connecting portion 621c may connect the first and second parallel portions 621a and 621b at alternating ends thereof.

The second refrigerant circulation pipe 622 may extend from the first side of the battery cells 110 to the second side thereof and may have a pipe shape, e.g., may be hollow at an inside thereof. The second refrigerant circulation pipe 622 may be adjacent to or in thermal co-operation with the first refrigerant circulation pipe 621 and the battery cells 110. For example, the second refrigerant circulation pipe 622 may contact a side surface of the first refrigerant circulation pipe 621 and lower surfaces of the battery cells 110. The second refrigerant circulation pipe 622 may be configured to supply refrigerant from the second side of the battery cells 110 through the hollow at the inside. For example, the second refrigerant circulation pipe 622 may be configured to supply refrigerant from the side where the sixth battery cell 110f is disposed. The second refrigerant circulation pipe 622 may include a first parallel portion 622a, a second parallel portion 622b, and a connecting portion 622c.

The first parallel portion 622a may be adjacent to or in thermal co-operation with the first parallel portion 621a of the first refrigerant circulation pipe 621 and the first battery cell 110a. The first parallel portion 622a may extend along the width direction of the first battery cell 110a.

The second parallel portion 622b may be adjacent to or in thermal co-operation with the second parallel portion 621b of the first refrigerant circulation pipe 621 and the second battery cell 110b. The second parallel portion 622b may extend along the width direction of the second battery cell 110b.

The connecting portion 622c may be adjacent to or in thermal co-operation with the connecting portion 621c of the first refrigerant circulation pipe 621. The connecting portion 622c may connect the first parallel portion 622a to the second parallel portion 622b in a curve shape, i.e., may be a curved pipe. Due to the curve shape of the second connecting portion 622c, refrigerant may flow efficiently.

The first parallel portion 622a, the second parallel portion 622b, and the connecting portion 622c of the second refrigerant circulation pipe 622 may be repeatedly formed according to the number and the size of the battery cells 110, i.e., the connecting portion 622c may connect the first and second parallel portions 622a and 622b at alternating ends thereof.

Hereinafter, a configuration of a battery pack according to still another embodiment will now be described.

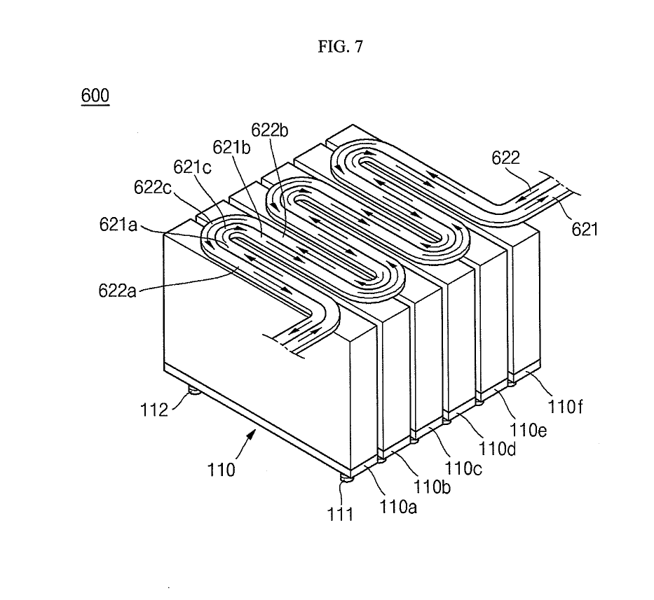

FIG. 8 illustrates a perspective view of battery pack according to the still another embodiment.

Referring to FIG. 8, a battery pack 700 according to the present embodiment is different from the battery pack 100 of FIG. 1 in that the battery pack 700 includes an intermediate medium 710. Thus, the battery pack 700 will now be described with respect to the intermediate medium 710. Like reference numerals denote like elements in the battery pack 100 of FIG. 1 and the battery pack 700, and repeated descriptions thereof will be omitted.

The intermediate medium 710 may be disposed between the battery cells 110 and the first refrigerant circulation pipe 121. When heat is generated during charge/discharge of the battery cells 110, the intermediate medium 710 may uniformly transfer the heat to the first refrigerant circulation pipe 121, without concentrating the heat at a single location. Accordingly, the intermediate medium 710 may effectively remove or transfer heat generated during charge/discharge of the battery cells 110. The intermediate medium 710 may be formed of a material with a thermal conductivity of greater than about 100 W/(m*K). In an implementation, the intermediate medium 710 may have a thin plate shape and be formed of a metal material having high heat conductivity, e.g., copper and/or aluminum.

As illustrated in FIG. 8, the intermediate medium 710 may be disposed between the battery cells 110 and the first refrigerant circulation pipe 121. However, when the battery cells 110 contact or are in thermal co-operation with the first and second refrigerant circulation pipes 421 and 422 at the same time, as illustrated in FIG. 5, the intermediate medium 710 may be disposed between the battery cells 110 and the first refrigerant circulation pipe 421, and simultaneously, may be disposed between the battery cells 110 and the second refrigerant circulation pipe 422.

Hereinafter, a configuration of a battery pack according to another embodiment will now be described.

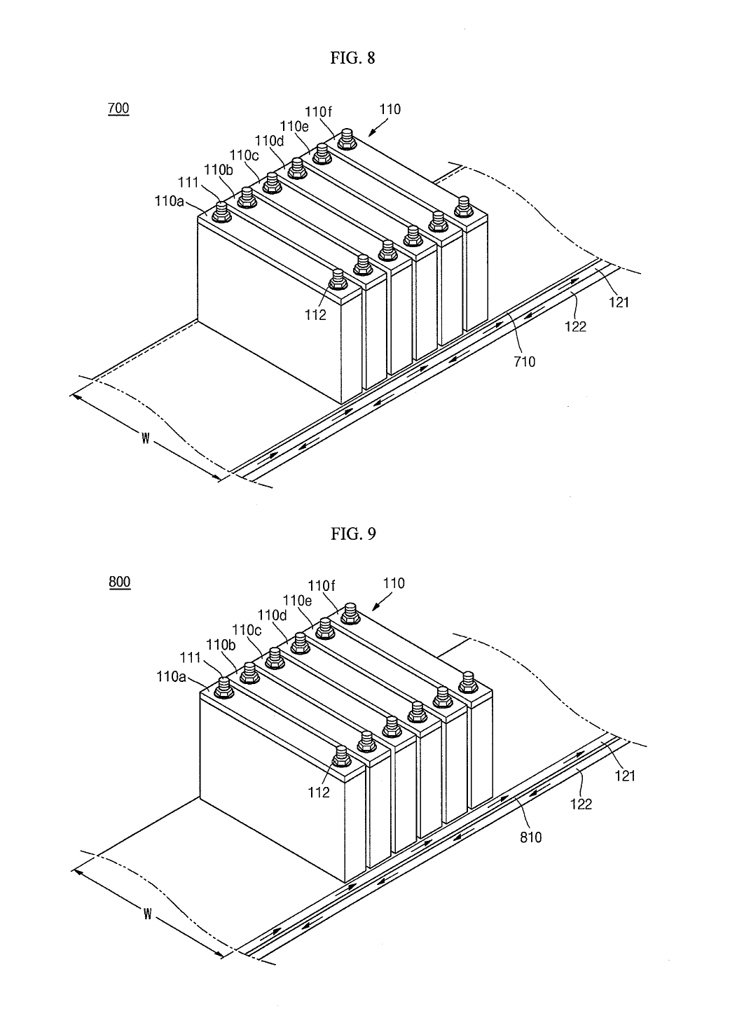

FIG. 9 illustrates a perspective view of battery pack according to still another embodiment.

Referring to FIG. 9, a battery pack 800 according to the present embodiment is different from the battery pack 100 of FIG. 1 in that the battery pack 800 includes an intermediate medium 810. Thus, the battery pack 800 will now be described with respect to the intermediate medium 810. Like reference numerals denote like elements in the battery pack 100 of FIG. 1 and the battery pack 800, and repeated descriptions thereof will be omitted.

The intermediate medium 810 may be disposed between the first refrigerant circulation pipe 121 and the second refrigerant circulation pipe 122. When the refrigerant of the first refrigerant circulation pipe 121 is heated by the battery cells 110, the intermediate medium 810 may uniformly transfer the heat to the second refrigerant circulation pipe 122 without concentrating the heat at a single location. Accordingly, the intermediate medium 810 may effectively remove or transfer heat generated during charge/discharge of the battery cells 110. The intermediate medium 810 may be formed of a material with a thermal conductivity of greater than about 100 W/(m*K). In an implementation, the intermediate medium 810 may have a thin plate shape and may be formed of a metal material having high heat conductivity, e.g., copper and/or aluminum.

According to the embodiments, the refrigerant circulation pipes, battery cells, and/or intermediate medium may be arranged in any combination of structures in which the circulation pipes, battery cells, and/or intermediate medium are in direct contact or indirect contact, e.g., any form of thermal co-operation.

The embodiments provide a cooling system for a battery pack that evenly cools heated battery cells, thereby ensuring satisfactory performance of the battery pack as a whole.

The embodiments provide a battery pack that can uniformly cool a plurality of battery cells so as to significantly improve stability.

A battery pack according to an embodiment may include refrigerant circulation pipes to cool or dissipate heat generated when battery cells are repeatedly charged and discharged. The refrigerant circulation pipes may direct refrigerant in opposing directions to uniformly cool the battery cells in the battery pack, so as to improve the stability and service life of the battery pack.

A battery pack according to an embodiment may include a control unit configured to circulate refrigerant only when desired to thereby minimize loss of power.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A battery pack, comprising:
a plurality of battery cells;
a first refrigerant circulation pipe; and
a second refrigerant circulation pipe adjacent to the first refrigerant circulation pipe, wherein:
the first refrigerant circulation pipe is configured to direct a refrigerant along a first circulation pathway,
the second refrigerant circulation pipe is configured to direct the refrigerant along a second circulation pathway counter to the first circulation pathway, and
at least one of the first refrigerant circulation pipe and the second refrigerant circulation pipe is in thermal co-operation with the battery cells.

2. The battery pack as claimed in claim 1, wherein:
the first refrigerant circulation pipe is configured to direct the refrigerant along the first circulation pathway in a first flow direction, and
the second refrigerant circulation pipe is configured to direct the refrigerant along the second circulation pathway in a second flow direction that runs counter to the first flow direction.

3. The battery pack as claimed in claim 1, wherein the first refrigerant circulation pipe is in thermal co-operation with the second refrigerant circulation pipe.

4. The battery pack as claimed in claim 3, wherein the first refrigerant circulation pipe is between the battery cells and the second refrigerant circulation pipe.

5. The battery pack as claimed in claim 4, wherein the second refrigerant circulation pipe has a shape substantially identical to a shape of the first refrigerant circulation pipe.

6. The battery pack as claimed in claim 1, wherein at least one of the first refrigerant circulation pipe and the second refrigerant circulation pipe contacts a surface of the battery cells to be cooled.

7. The battery pack as claimed in claim 1, further comprising:
a first refrigerant supply pipe connected to a first end of the first refrigerant circulation pipe,
a second refrigerant supply pipe connected to a second end of the second refrigerant circulation pipe,
a pumping system configured to supply the refrigerant to the first and second refrigerant supply pipes,
a first refrigerant discharge pipe connected to a second end of the first refrigerant circulation pipe, the second end of the first refrigerant circulation pipe being opposite to the first end thereof,
a second refrigerant discharge pipe connected to a first end of the second refrigerant circulation pipe, the first end of the second refrigerant circulation pipe being opposite to the second end thereof, and
a heat dissipation storage system connected to the first and second refrigerant discharge pipes, the heat dissipation storage system being configured to cool and store refrigerant from the first and second refrigerant discharge pipes and being configured to supply cooled refrigerant to the pumping system.

8. The battery pack as claimed in claim 7, wherein the pumping system includes a single pump connected to the first refrigerant supply pipe and the second refrigerant supply pipe.

9. The battery pack as claimed in claim 7, wherein the heat dissipation storage system includes a single heat dissipation storage unit connected to the first and second refrigerant discharge pipes.

10. The battery pack as claimed in claim 7, wherein the pumping system includes a plurality of pumps, at least one pump being connected to the first refrigerant supply pipe and at least one other pump being connected to the second refrigerant supply pipe.

11. The battery pack as claimed in claim 7, wherein the heat dissipation storage system includes a plurality of heat dissipation storage units, at least one heat dissipation storage unit being connected to the first refrigerant discharge pipe and at least one other heat dissipation storage unit being connected to the second refrigerant discharge pipe.

12. The battery pack as claimed in claim 7, further comprising a control unit operatively coupled with the pumping system, the control unit being configured to measure a temperature of the battery cells and control operation of the pumping system.

13. The battery pack as claimed in claim 12, wherein the control unit is configured to activate the pumping system when a temperature of the battery cells exceeds a predetermined reference temperature.

14. The battery pack as claimed in claim 7, further comprising a branch supply pipe connected between the pumping system and the first and second refrigerant supply pipes.

15. The battery pack as claimed in claim 7, further comprising a branch discharge pipe connected between the first and second refrigerant discharge pipes and the heat dissipation storage system.

16. The battery pack as claimed in claim 1, wherein the first refrigerant circulation pipe has a width about equal to a width of the second refrigerant supply pipe.

17. The battery pack as claimed in claim 16, wherein the battery cells have a width about equal to a sum of the widths of the first and second refrigerant circulation pipes.

18. The battery pack as claimed in claim 1, wherein the first and second refrigerant circulation pipes each include parallel portions and connecting portions, each parallel portion extending along a widthwise direction of a battery cell and the connecting portions connecting the parallel portions at alternating ends of the parallel portions.

19. The battery pack as claimed in claim 18, wherein the connecting portion is a straight pipe extending between the parallel portions.

20. The battery pack as claimed in claim 18, wherein the connecting portion is a curved pipe extending between the parallel portions.

21. The battery pack as claimed in claim 1, wherein the first refrigerant circulation pipe is coplanar with the second refrigerant circulation pipe.

22. The battery pack as claimed in claim 21, wherein the connecting portion is a curved pipe extending between the parallel portions.

23. A cooling system for a battery pack that includes a plurality of battery cells, the cooling system comprising:
a first refrigerant circulation pipe; and
a second refrigerant circulation pipe adjacent to the first refrigerant circulation pipe, wherein:
the first refrigerant circulation pipe contacts a surface of the battery cells to be cooled and is configured to direct a refrigerant along a first circulation pathway in a first flow direction, and
the second refrigerant circulation pipe co-operates with the first refrigerant circulation pipe and is configured to direct the refrigerant along a second circulation pathway in a second flow direction that runs counter to the first flow direction.
